(19) United States
(12) Patent Application Publication
(10) Pub. No.: US 2014/0100499 A1
(43) Pub. Date: Apr. 10, 2014

(54) METHOD FOR CALMING A PERSON

(71) Applicant: Reizel Polak, Brookline, MA (US)

(72) Inventor: Reizel Polak, Brookline, MA (US)

(21) Appl. No.: 13/648,323

(22) Filed: Oct. 10, 2012

(51) Int. Cl. A61H 7/00

(52) U.S. Cl. 601/148

(57) ABSTRACT

The present invention relates to a method for reducing emotional dysregulation in a person is disclosed herein. The method includes uses an inflatable cushion which has an attachment for a vacuum pump and includes identifying a person having emotional dysregulation, placing the emotionally dysregulated person upon the cushion so that the cushion extends at least the length of the emotionally dysregulated person's torso, eliminating a sufficient amount of air from the cushion so that the cushion at least partially envelops the emotionally dysregulated person, and keeping the emotionally dysregulated person in the enveloped cushion for a sufficient time for reducing the person's emotional dysregulation.

### BACKGROUND OF THE INVENTION

1. Field of the Invention

The present invention generally relates to a method for calming a person. Specifically, the present invention discloses a therapeutic intervention for reducing emotional dysregulation in a person. In particular, the present invention discloses a method for producing a calming effect upon a population of people having a range of dysregulated emotions and behaviors by using an inflatable cushion. Such use of the cushion can provide a calming effect upon such persons with heretofore unrealized results.

2. Description of the Related Art

Many techniques have been used to address dysregulated emotional behavior. Such techniques include behavior modification, self-management skills, systems of reward and punishment, and a variety of other therapies.

Typical therapies have, as a matter of policy, no physical contact, i.e. no normative contact, no hugs, no arms around a shoulder, no pat on the back. Only the following are typically permitted: high fives, first pound, elbow to elbow, and handshakes. However, all therapies have had limited success. There is therefore a great need for a method which can address such negative emotional and behavioral issues with a successful outcome.

Accordingly, there is now provided with this invention an improved method for reducing emotional dysregulation in a person thereby effectively overcoming the aforementioned difficulties and longstanding problems in behavioral therapy.

### SUMMARY OF THE INVENTION

According to one aspect of the invention, a method for reducing emotional dysregulation in a person is disclosed herein. The method includes using an inflatable cushion which has an attachment for a vacuum pump and includes identifying a person having emotional dysregulation, placing the emotionally dysregulated person upon the cushion so that the cushion extends at least the length of the emotionally dysregulated person's torso (i.e., either placing directly or, preferably, allowing the person to place himself or herself on the cushion), eliminating a sufficient amount of air from the cushion so that the cushion at least partially envelops the emotionally dysregulated person, and keeping the emotionally dysregulated person in the enveloped cushion for a sufficient time for reducing the person's emotional dysregulation. The envelopment of the emotionally dysregulated person provides a safe and comfortable pressure against that person's body, as will be discussed herein.

As will be appreciated by those persons skilled in the art, a major advantage provided by the present invention is that a calming effect is produced upon the emotionally dysregulated person. Additional objects of the present invention will become apparent from the following description.

The foregoing Summary of the Invention is not intended to limit the scope of the disclosure contained herein nor limit the scope of the appended claims. To the contrary, as will be appreciated by those persons skilled in the art, variations of the foregoing described embodiments may be implemented without departing from the claimed invention.

### DESCRIPTION OF THE PREFERRED EMBODIMENT

The following preferred embodiment as exemplified by the method described herein is illustrative of the invention and is not intended to limit the invention as encompassed by the claims of this application. Although the inventive method is described herein as applied to a student in a school setting, such a setting is merely for descriptive purposes and can be applied in a variety of settings to a variety of persons exhibiting negative behavior, for example, dysregulated behavior.

Those exhibiting dysregulated behavior, adolescent students, as an example, are legion and those with whom the present method of therapy may be used are manifold. Such dysregulated behavior may be, for example, the result of brain injury, resulting in cognitive deficits; early childhood sexual abuse; acts of abuse and sexualized behaviors; results of early childhood neglect and violence; attachment disorders, dissociative disorder; inability to tolerate distress; regulate emotions; lack of inhibition regarding anger, frustration, disappointment; a range of acting out behaviors, verbal and physically assaultive behaviors; a range of neurological disorders including, e.g., Asperger's Syndrome and the Autistic spectrum, Pervasive Developmental Disorder; mild and severe cognitive retardation.

The cushion used in the method of the present invention, was originally designed for radiation treatment to immobilize the student for accuracy of treatment. It has now been found that the use of this cushion has a calming effect with those exhibiting dysregulated behavior particularly in a setting with administrative policy that prohibits normative physical contact, i.e. arms around, a pat on the back, or hugs, policy that is at the same time necessary for maintaining healthy personal boundaries for this population. The cushion works in a similar way as Temple Grandin's Squeeze machine. Yet the cushion used herein is a simpler design, easily portable, cost effective, and may help to offset the kinds of acting out incidents of this population. Moreover, because the individual is provided with a feeling of being held simulating the secure feeling a child feels when held by a caring adult, the cushion helps to create a more secure sense of boundaries with those individuals who do not experience healthy personal boundaries.

The process for implementing the method may begin with consent, including consent by parents or guardians of the recipient student. It may be important for the students to know that the cushion was approved by their parents.

Initial Introduction: To begin, each student is interviewed using a questionnaire with questions determining their awareness of their triggers, and strategies to maintain or regain a state of calm. Before the interview, opportunities to informally interact with these students may be chosen so that the administrator of the method would not only be familiar to them, but also be seen as a friendly, supportive presence. Regarding cooperation, it is crucial that a therapeutic alliance, i.e. a trusting relationship first be established. If necessary for cooperation, a program-token reward may be offered. However, not every student cares about a reward.

In the interview, another therapist/administrator may take notes. Each student is asked about their willingness to try something new that might help them to manage better their hard-to-manage emotions and behaviors. It is important to make it clear that it is entirely the student's choice without any negative consequence should the student refuse.

How a session is initiated may vary with each individual, for example, where they are, what they are doing, the time of day, whether they are likely to be hungry, or if they are on the way to an anticipated activity.

Initiation of sessions is preferably by invitation, for example, one may ask the student, “Is it a good time for you to use the cushion?”. Alternatively, one may not ask whether the student wants to use the cushion, but rather where he should go to use it, i.e. which room among available rooms. If the student is involved in another activity, e.g. drawing or on the computer, it may be necessary to briefly speak with them to determine their need for transition time: whether they'd like a few more minutes or whether they'd like to schedule another time. Such an option only occurs when there is not an overt behavioral issue.

How the cushion works is then physically demonstrated for each individual. Even though the cushion has the effect of synthesizing a hug-like feeling, reference to a “hug” is not made, knowing the background of the students where associations with “hugs” could be detrimental or overly stimulating. The term “hug” is not to be used, rather, when asking for feedback, use words such as “comfortable”, “relaxing”, “calm”, etc.

For every occasion of use, an Information Sheet with basic data is typically kept. In the minutes of preparing the cushion there is minimal talking by the therapist. Privacy is essential. The student is shown the preparation of the cushion, evening out bumps, for example. Students may want to help with the smoothing process, which can be a problem if they have rigorous, aggressive movements. Such help should be discouraged, although a student can help with covering the cushion with their personal sheet, if they want to. If a pillow is preferred, it is also covered with the sheet.

The cushion, placed flat on the floor, is situated to avoid strong sunlight and is placed close enough to an electrical outlet. The cushion is positioned for the student to lie down from head to foot with the corner that has an inlet nozzle for the pump closest to the student's feet. The student lies down on the cushion, positioned vertically in the middle of the cushion. A vacuum pump is then connected to the nozzle. The pump is plugged in but not yet turned on.

The student is typically told that the noise from the pump sounds something like a hair dryer. The student is asked where they want to place their hands for comfort; on their stomach, at their side, or over their head. If the position of their hands will keep the sides of the cushion at a distance, thereby minimizing optimal pressure, another position is suggested for their arms and hands. The student is asked to rate their level of calm before starting, on a scale of 1 to 10, 1 being the calmest. Although the students' ratings do not always match what their body language shows, there is benefit in having them rate their level of calm.

Before turning on the pump, the student is asked whether they are comfortable and ready. The exact time for timing the duration of use is noted, using an Information sheet. Often, 15 minutes is optimum to achieve the desired calming effect.

The pump is turned on to a vacuum function while the sides of the cushion are held against the side of the patient. Another staff member may be employed so that the therapist and the assistant are positioned on opposite sides of the cushion each holding the cushion's side against the student's side thereby creating pressure against the student's body. The student is asked when the “fit” of the cushion feels best.

The change from a soft, limp bean bag to a safe pressure forming a snug form is what begins to induce a feeling of calm. As used herein, “safe” may be defined as any pressure that is not harmful to the patient, with no non-transient negative physiological effect on the body. “Safe” pressure may be one that does not substantially constrain or substantially restrain the patient's body such that the patient can move out of the cushion at will. “Safe” pressure may further include pressure sufficient to provide a positive feeling of being held in a comfortable secure hold. Currently utilized pumps typically take 4 to 5 minutes to produce the desired safe pressure. The pump is then turned off and disconnected from the outlet.

Once the student is lying in the cushion, they are given the option to lie quietly, talk, listen to music or do a breathing exercise. The student is not left alone. If they prefer to lie quietly, the therapist sits at a distance noting the student's body language and any remarks they make.

It may sometimes be necessary to gently engage the student in talking about their day, or to talk about a particular incident. The details of these exchanges, are, in some cases, significant for how easily the student could report on a situation they would otherwise avoid speaking about.

Typical treatment times to achieve a calming effect are in the order of fifteen minutes of lying in the cushion. If a student gets up sooner, the therapist asks if they want to stay a little longer. If fifteen minutes passes and the student looks fully relaxed, the student is asked if they are ready to get up. The student is asked how lying in the cushion affected them and to rate their level of calm compared to how they rated their level of calm as they did before they used the cushion. The student is accompanied to a storage area in which the cushion, the pump, and the sheet may be stored. The student is then walked back to wherever they are scheduled to be and praised for how well they did.

The cushion is basically a rectangular shaped bean bag and is a novel therapeutic application of a product that was originally devised and is currently used for radiation treatment. The cushion is manufactured by Bionix as, “SecureVac Immobilization System”, found, for example, at: http://www.bionixrt.com/RT Pages/SecureVac.html. Other model's include: RT-7625/T-Vac Dual-Chamber SecureVac Cushion and RT-7600/Tri-Vac SecureVac Cushion. Bionix's description is, “ . . . durable, accurate and cost-effective . . . reusable and airtight filled with small polystyrene spheres to immobilize the student . . . made of nylon material . . . stronger to prevent punctures and leaks; adaptable to industry standard pumps”. It is available in a variety of sizes and fills to meet treatment needs. The pump used herein is Bionix's RT-7101/SecureVac Pump.

While this description suggests immobilization, in fact, the cushion itself is not a restraining device. In radiation treatment, it can achieve precision. The student can easily move in and out of the cushion, which is formed to fit their torso or full body length. The individual form is produced by the vacuum pump. The present method is consistent with there being no constraints, or restraining feature. No side effects or risks are involved with its use.

The shape of the cushion is ultimately formed by the withdrawal of air from the cushion while the individual is lying on it. Because the cushion is reusable, each individual typically has their own sheet to lie on over the cushion. A pillow may optionally be used if desired. Each cushion, starting in the form of a flat bean bag, is formed into the shape of the individual's torso while the individual is lying on the cushion. This process, itself, individual find relaxing.

The cushion may be used, in some cases, when the individual is in a fairly controlled state. In some cases, it may be used to prevent escalation of an agitated state. After they have been exposed to the present method of therapy, individuals may request use of the cushion themselves.

Cushions may be maintained in the individual's form from week to week, as long as six to eight weeks (i.e., may be “previously formed” prior to use in a particular session). Alternatively, they may be reformed for each occasion of use. Each use has its associated advantage. For the individual who has no tolerance to wait, who is ambivalent about using the cushion, and who is motivated by a token reward, having the already formed cushion is a great advantage. Forming the cushion for each occasion of use has additional advantage of the individual experiencing an increasing sense of pressure with each use where the individual informs the therapist when it is most comfortable.

In some circumstances, at the onset of a negative behavior, if a individual doesn't make the choice to take a self-time-out, someone on the staff of the program administering the present method will direct the individual to a Time Out space to calm down. This method has many steps depending on the extent of the negative behavior. If the negative behavior escalates, as necessary, staff will put hands on the individual i.e. two staff will lock arms on either side of the individual, in an Escort. If the individual's behavior continues to escalate, staff will safely take the individual down into a restraint. A restraint lasts as long as necessary until the individual regains control and is calm enough to rejoin the community.

### Example

It is to be understood that the following example of the present invention is not intended to restrict the present invention since many more modifications may be made within the scope of the claims without departing from the spirit thereof.

An example of the information and questions included in a typical consent form may be: name of parent, name of student and a description and duration of the treatment method. Such a treatment may be described as: “The Intervention will provide a comfort cushion for sensory soothing in conjunction with routine behavior management and self-management procedures already in place. The purpose of the Intervention is to determine, if by using the cushion, either in moments of distress or at a scheduled time, that the use of the cushion will sustain the student's emotional regulation and decrease the overall number of behavioral incidents. The use of the cushion by the student is entirely voluntary. A staff member will be present at all times when the cushion is in use should the student experience distress. Consent can be withdrawn at any time.” The cushion may be described as: “The cushion is made of thick durable nylon. It will be shaped for each student's torso, from the back, or from the front, from neck to waist, to lie in easily, with comfort and without any restraint. The cushion will be formed with the student's participation. The student may remove him/herself from the cushion at any time.”

An example of the preliminary questions that may be asked of the student to assess their participation may include, for example, “What triggers you, gets you frustrated and angry, and feeling out of control? Name as many as you can. When you are triggered, what is the most helpful way you can get calm again? Say whatever you can. When you feel frustrated, disappointed, or angry, or on the positive side, excited or happy, how do you manage to stay in control? Say whatever comes to mind. What is the hardest part of your day? What is the best part of your day? How do you feel if someone accidentally touches you or bumps against you? Is there a feeling this triggers in you? Would you say that you know how to calm yourself when you start to feel overwhelmed by feelings or thoughts? Would you be willing to try something new that might help you feel more comfortable in yourself and calmer at times when you start to lose it? This would be using a kind of comfort cushion.

### Individual Data from Experimental Use

Data from a pilot intervention using the method of the present invention by the inventor is as follows. (Names not used. Individuals are referred to as Student A, B, C, D, E; genders not designated: 2 females, 3 males).

35. Counting 17 weeks from the beginning of the Intervention in February to week of Jun. 11, 2012, noting that the therapist was away almost 2 weeks of that time. Student B. the exception, used the cushion over an 8 week period. Student E, who started after the others, used the cushion over a 16 week period.

36. Quantitative Data are Selective Remarks by students and Selective Observations by me:

37. Student B:
Frequency per wk.: over 8 wks./2× a wk
Time of day: 3:30 pm
Duration& Total # of uses: 1× for 3 wks.
Location: in dorm room
Total minutes Average: 111 min. 9½ min
Total # of uses: 12
Student: You interrupted my video game for this? I don't see how it can work.
Me: Asked if Student B wanted me to stay or wait at the doorway of the room. Wanted me to stay; happily accepted a token reward after use.
Student: Complained about a new peer; complained about being in this program; refused to lie in the already formed cushion; agreed to use it for 8 minutes.
Student: Let's get this over with. How much longer. Video games are my stress relievers.
Me: Took several requests to have Student B put the video game on pause; Paused, then got into the Cushion.
Student: I'm lying in it, using it for 2 minutes to help me relieve some of my stress. Used it for 5. Student: Took initiative to stop by my office door to inform me of the week's schedule; wanted to tell me B is free tomorrow [for the cushion]. In subsequent sessions, became more talkative. B said B only used the cushion for the reward. Student B used the cushion the least amount of time; is the only student who did not show a difference regarding behavioral incidents.

Student C:
Frequency per wk.: 7 wk/1× in dorm room; 9.9 min, 2 wk/2× in the community room
Time of day: 4 pm
Total # of uses: 14, using a ready-made cushion, custom made.
Student: It's good. Asked if Student C could take the cushion home. Told mother C loves the cushion; it makes C feel very relaxed, that C likes how it feels around C's [body].
Me: Student C has high energy, is easily triggered by interactions on the bus at the end of the day.
Student: Agitated by an incident earlier in the day. Accepted the cushion immediately. Asked if C could take the cushion home. Was more focused while lying in the cushion than usual, able to have a conversation.
Student: I did the breathing you showed me.
Me: After use, observed C smiling, enthusiastically coming to tell me C is on the Level that allows for going off grounds shopping.
Student: (Hearing loud noise from a peer) Stayed atypically calm and quiet in the cushion; given the option, requested a cushion that has to be formed.

Student A:
Frequency per week/Duration& Total # of uses: —8 wk/1×6 wk/2×; 1 wk/3×1 wk/5×.
Time of day: 2 pm
Location: Community room
Total minutes: 387 min.
Average: 13.3 min.
Total # of uses: 29
Student: I feel relaxed. [fully cooperative]. It felt snug. It felt calm. Described feeling calmer after using it, having been sent to Time Out earlier where A was standing on the bench screaming Time Outs are for babies.
Me: Accepting limits better where limits are a big challenge for Student A.
Student: Complaining of body aches.
Me: Directing A while A is lying in the cushion to do breathing and focus on the part of the body that is achy. For each set of breaths, A reports feeling better [not clear that the complaints were founded]. Body language calmer after cushion.

Student E:
Frequency per week/Duration& Total # of uses: 5 wk/1×
Time: 12 Noon
Location: Community room
Total minutes: 347 min.
Average minutes: 15.2 min.
Frequency per week/Duration& Total # of uses: 5 wk/2×; 2 wk/3× Total # of uses: 23
Student: First use, mentioned Temple Grandin's Squeeze machine. E said E hopes the cushion will help E feel less anxious, less tense. [Listens to CD's with eyes closed].
Me: lying looking atypically relaxed.
Me: via reporting from staff: Student E said E enjoys the calm, soothing feeling E receives from the cushion. Admits to having a restless mind. the cushion feels like a big hug.

Student D:
Frequency per week/Duration: 9 wk/1×; Varied
Location: dorm room
Total minutes: 195 min.
Average minutes: 13 min.
Time: 3:30 pm
Total # of uses: 15
Student: making provocative remarks; admitted to feeling hyper. [the cushion] feels good. making loud singing tones; singing a favorite song. became completely relaxed, talked minimally, when talking was completely appropriate, a chronic challenge for Student D.

### Specific Data Sums for the Intervention

It's important to note that the sums below should be taken into account in relation to the qualitative data and that the sums do not reflect the situation in which an Incident occurred. The sums that indicate a student taking initiative for a Self Time Out are the most notable, in the cases of Student D, A, and B. Student E taking fewer Self Time Outs is a positive indicator for her. The nomenclature is as follows:
Ed: School Day
Res: After school, residential time
T.O.: Time Out initiated by staff
Self: A Time Out initiated by student. Taking Self Time-Outs is a goal of self-management.
Escort: Staff walk on either side of a student with their arms locked under the student's elbows
Restraint: staff take a student down due to the student's assaultive behavior

Student D:

| | Before | After |
|---|---|---|
| Ed T.O. | 43 | 61 |
| Res T.O. | 14 | 18 |
| Ed Selfs | 2 | 16 |
| Ed Escorts | 2 | 3 |
| Res Escorts | 5 | 0 |
| Ed Restraints | 1 | 3 |
| Res Restraints | 2 | 0 |

Student A:

| | Before | After |
|---|---|---|
| Ed T.O. | 49 | 43 |
| Res T.O. | 81 | 57 |
| Ed Selfs | 21 | 20 |
| Ed Escorts | 1 | 2 |
| Res Escorts | 7 | 7 |
| Ed Restraints | 3 | 1 |
| Res Restraints | 3 | 6 |

Student C:

| | Before | After (is only a residential student) |
|---|---|---|
| Res T.O. | 37 | 0 |
| Res Escorts | 3 | 0 |
| Res Restraints | 2 | 0 |

Student E: does not have overt behavioral issues, but experiences intense social anxiety.

| | Before | After |
|---|---|---|
| Ed T.O. | 2 | 0 |
| Ed Selfs | 10 | 6 |
| Ed Escorts | 0 | 0 |
| Ed Restraints | 0 | 0 |
| Ed T.O. | 2 | 0 |
| Ed Selfs | 10 | 6 |
| Ed Escorts | 0 | 0 |
| Ed Restraints | 0 | 0 |

### Summary of Additional Results for the Calming Cushion

Jun. 6, 2012: Of the five students currently involved in this Pilot Intervention, here are some results: (these results will have a greater impact when presented in the context of each student's profile and life situation).

Student C: Before—frequent restraints; After—No restraints since starting use of the cushion; Has taken more Self Time Outs. Has had fewer staff Time Outs. In Student C's own words says there is a calmer feeling as a result of using the cushion. It should be noted that Student C typically exhibits inattention and hyper levels of energy. In sessions using the cushion, Student C showed an unusual capacity to stay focused and make eye contact while talking to the therapist.

Student A: Before—frequent restraints; After—Has had fewer Escorts and Restraints; Has same number of Staff Time Outs, but is taking more Self Time Outs during the school day; Has requested the cushion when feeling frustrated or angry.

Student E: has to manage intense anxiety. No staff Time Outs since starting the cushion.

Student D: Before—Had 5 Staff Time Outs a day; After—fewer Staff Time Outs, is taking more Self Time Outs than before.

Student B: Before and After—Restraints are the same; Student B used the cushion the least amount of time compared to the other students.

It is the safe pressure, and the secure, comforting feeling of being held that might be internalized, and in time may provide a sense of being more connected to one's body and to experience a feeling of well-being exercising more control of one's behavior. Expected results include a decrease in incidents related to acting out behaviors and need for restraints. Further, this treatment method has application for other populations and programs, for facilities or institutions serving those with cognitive disabilities, psychiatric disorders, or those on the autistic spectrum. The use of the cushion could be applied to those who have experienced trauma, such as domestic violence, sexual assault, or the result of terror. It could be applied to detox programs. All of the above would require research studies to validate the efficacy of the calming effect, short and long term, of the cushion.

The method, as mentioned, could be applied to those on the Autistic spectrum, as a possible “hugging” cushion, akin to Temple Grandin's hug/squeeze machine. Other possible applications may include populations of those suffering from, back pain, babies with colic, frail elders, and difficulties arising during pregnancy. Addressing loneliness should be a consideration in researching those with debilitating depression.

Although the particular embodiments shown and described above will prove to be useful in many applications in the therapeutic art to which the present invention pertains, further modifications of the present invention will occur to persons skilled in the art. All such modifications are deemed to be within the scope and spirit of the present invention as defined by the appended claims.

What is claimed is:

1. A method for reducing emotional dysregulation in a person, using an inflatable cushion having an attachment for a vacuum pump, comprising:
a. identifying a person having emotional dysregulation;
b. placing the emotionally dysregulated person upon the cushion so that the cushion extends at least the length of the emotionally dysregulated person's torso;
c. eliminating a sufficient amount of air from the cushion so that the cushion at least partially envelops the emotionally dysregulated person; and
d. keeping the emotionally dysregulated person in the enveloped cushion for a sufficient time for reducing the person's emotional dysregulation.

2. The method of claim 1, wherein the emotionally dysregulated person is diagnosed on the autistic spectrum.

3. The method of claim 1, further comprising detaching the vacuum pump from the attachment and retaining the vacuum in the cushion.

4. The method of claim 1, wherein the cushion snugly envelops the emotionally dysregulated person.

5. The method of claim 1, further comprising removing the person from the enveloped cushion and retaining the cushion in the enveloped state for another session with the same person.

6. The method of claim 1, wherein the cushion has a check valve operatively attached to the attachment.

7. The method of claim 3, wherein the vacuum pump has a pressure gauge for determining the pressure in the enveloped cushion.

8. The method of claim 1, further comprising speaking to the person when enveloped in the cushion.

9. The method of claim 8, further comprising holding the cushion against the person during the elimination step.

10. The method of claim 9, wherein the enveloped cushion forms a snug fit with the torso of the person.

11. A method for reducing emotional dysregulation in a person, using an inflatable cushion having an attachment for a vacuum pump, comprising:
a. initiating a treatment session for an emotionally dysregulated person;
b. determining whether transition time is required for the person prior to beginning treatment and providing such transition time if so required;
c. determining whether a pre-formed inflatable cushion exists for the emotionally dysregulated person;
d. if a pre-formed inflatable cushion does exist as determined in step (c), enveloping at least in part the emotionally dysregulated person using such cushion;
e. if a pre-formed inflatable cushion does not exist as determined in step (c), eliminating a sufficient amount of air from the cushion so that the cushion at least partially envelops the emotionally dysregulated person; and
f. keeping the emotionally dysregulated person in the enveloped cushion for a sufficient time for reducing the person's emotional dysregulation.

12. The method of claim 11, wherein step (e) includes the step of holding the cushion's sides against each side the emotionally dysregulated person's sides.

13. The method of claim 11, wherein step (e) includes the step of obtaining verbal feedback from the emotionally dysregulated person regarding the fit of the cushion.

14. The method of claim 12, wherein step (e) includes the step of obtaining verbal feedback from the emotionally dysregulated person regarding the fit of the cushion.

15. The method of claim 11, further comprising the step of removing the person from the enveloped cushion and retaining the cushion in the enveloped state for another session with the same person.

16. The method of claim 12, further comprising the step of removing the person from the enveloped cushion and retaining the cushion in the enveloped state for another session with the same person.

17. The method of claim 13, further comprising the step of removing the person from the enveloped cushion and retaining the cushion in the enveloped state for another session with the same person.

18. The method of claim 14, further comprising the step of removing the person from the enveloped cushion and retaining the cushion in the enveloped state for another session with the same person.
